(19) United States
(12) Patent Application Publication
(10) Pub. No.: US 2016/0104895 A1
(43) Pub. Date: Apr. 14, 2016

(54) TEMPLATED NON-CARBON METAL OXIDE CATALYST SUPPORT

(71) Applicant: NISSAN NORTH AMERICA, INC., Franklin, TN (US)

(72) Inventors: Ellazar Niangar, Redford, MI (US); Gregory DiLeo, Ann Arbor, MI (US)

(21) Appl. No.: 14/974,326

(22) Filed: Dec. 18, 2015

Related U.S. Application Data
(62) Division of application No. 14/169,574, filed on Jan. 31, 2014.

(51) Int. Cl. H01M 4/88; H01M 4/90

(52) U.S. Cl. CPC H01M 4/8817; H01M 4/9075; H01M 2008/1095

(57) ABSTRACT

Non-corrosive, non-carbon metal oxide support particles are formed with pre-shaped, templated vacancies. Electrocatalysts, membrane electrode assemblies and fuel cells can be produced with the templated non-corrosive, non-carbon metal oxide support particles.

### CROSS REFERENCE TO RELATED APPLICATION

This application is a divisional application of U.S. patent application Ser. No. 14/169,574 filed Jan. 31, 2014, the contents of which are incorporated herein by reference in their entirety.

### TECHNICAL FIELD

This disclosure relates to templated non-carbon metal oxide catalyst support used to produce electrocatalysts for hydrogen fuel cell vehicles having active catalyst particles deposited thereon.

### BACKGROUND

Carbon has traditionally been the most common material of choice for polymer electrolyte fuel cell (PEFC) electrocatalyst supports due to its low cost, high abundance, high electronic conductivity, and high Brunauer, Emmett, and Teller (BET) surface area, which permits good dispersion of platinum (Pt) active catalyst particles. However, the instability of the carbon-supported platinum electrocatalyst is a key issue that currently precludes widespread commercialization of PEFCs for automotive applications.

Carbon is known to undergo electrochemical oxidation to carbon dioxide. Despite the fact that the cathode potential is usually significantly higher than the standard potential for carbon oxidation, the actual rate of carbon oxidation is very slow due to a very low standard heterogeneous rate constant. During operation of automotive PEFC stacks, fuel/air mixed fronts are known to occur during stack startup and shutdown. Air usually fills the flow channels when the stack is nonoperational. During startup, the hydrogen fed into the stack displaces the air from the anode flow channels, leading to a mixed fuel-oxidant. These mixed-reactant fronts result in significant electrode polarization. Under these conditions, the PEFC cathode can experience high potentials, corresponding to a significantly higher overpotential for the carbon oxidation reaction. The electrochemical reaction rate constant, which increases exponentially with overpotential, is significantly enhanced during this period. Under these conditions, carbon corrosion is exacerbated.

In a second mechanism, fuel starvation at the anode catalyst sites as a consequence of fuel overutilization or flooding (lack of fuel access to catalyst site) also exacerbates carbon corrosion. In this case, carbon is oxidized to provide protons and electrons in place of the absent fuel.

The adverse consequences of carbon corrosion include (i) platinum nanoparticle agglomeration/detachment; (ii) macroscopic electrode thinning/loss of porosity in the electrode; and (iii) enhanced hydrophilicity of the remaining support surface. The first results in loss of catalyst active surface area and lower mass activity resulting from reduced platinum utilization, whereas the second and third result in a lower capacity to hold water and enhanced flooding, leading to severe condensed-phase mass transport limitations. Clearly, both consequences directly impact PEFC cost and performance, especially in the context of automotive stacks.

### SUMMARY

Support particles comprising non-corrosive, non-carbon metal oxides are disclosed as well as the method of making the support particles. Membrane electrode assemblies and fuel cells comprising the membrane electrode assemblies are also disclosed.

In one embodiment, the non-carbon support particle for use in electrocatalyst comprises a first metal oxide and a second metal oxide. At least one of the first metal oxide and the second metal oxide has templated vacancies configured to increase a surface area of the non-carbon support particle. In one aspect, the first metal oxide has the templated vacancies, and the second metal oxide is deposited onto the first metal oxide. In another aspect, the first metal oxide and the second metal oxide form a composite mixed metal oxide having the templated vacancies.

Also disclosed are methods of making the non-corrosive non-carbon metal oxide support particles and making electrocatalysts using the support particles. One method comprising forming a metal oxide around a templating material and removing the templating material to produce vacancies in the metal oxide. A second metal oxide can be deposited onto the first metal oxide having the vacancies to complete the non-carbon support. The metal oxide can be a composite metal oxide that is formed over the templating material, the composite metal oxide comprising a first metal oxide and a second metal oxide.

These and other aspects of the present disclosure are disclosed in the following detailed description of the embodiments, the appended claims and the accompanying figures.

### BRIEF DESCRIPTION OF THE DRAWINGS

The various features, advantages and other uses of the present apparatus will become more apparent by referring to the following detailed description and drawing in which:

FIG. 1 is a schematic of an embodiment of templated non-carbon composite metal oxide support particles as disclosed herein;

FIG. 2 is a flow diagram of a process of preparing the non-carbon support particles of FIG. 1;

FIG. 3 is a schematic of another embodiment of templated non-carbon composite metal oxide support particles as disclosed herein;

FIG. 4 is a flow diagram of a process of preparing the templated non-carbon composite metal oxide support particles of FIG. 3; and

FIG. 5 is a schematic of a fuel cell utilizing the electrocatalyst disclosed herein.

### DETAILED DESCRIPTION

A viable alternative non-carbon support should possess high surface area and electron conductivity, in addition to being highly corrosion resistant across the anticipated potential/pH window. Metal oxides are corrosion resistant, but can vary in their conductance and surface area. Examples of metal oxides include, but are not limited to, MnOₓ, CuO, ZnO, FeOₓ, Cr₂O₃, TiO₂, SnO₂, Nb₂O₅, WO₃, In₂O₃, Sb₂O₃, CeO₂ and RuO₂ and combinations thereof.

Disclosed herein are non-corrosive non-carbon metal oxide support particles used in electrocatalysts that have a high surface area. To increase the surface area of the support, one or more metal oxides are formed around a shape-defined template. The template is then removed, leaving the metal oxide substrate with the desired shape or structure having an increased surface area. The support can be further prepared by adding or depositing one or more other metal oxides on the metal oxide substrate.

FIG. 1 is a schematic of a first embodiment of a non-corrosive non-carbon metal oxide support particle. In a first embodiment, a first metal oxide MO1 is formed around a templating material T. The templating material T is then removed, forming templated vacancies V in the first metal oxide MO1 where the templating material T was removed. A second metal oxide MO2 is then deposited onto the first metal oxide MO1, depositing on the surface of the first metal oxide MO1 as well as within the vacancies V, to form the non-carbon metal oxide support.

The particle size of the first metal oxide MO1 can be larger than the particle size of the second metal oxide MO2. By depositing smaller particles onto a larger substrate, interface surfaces can be optimized to improve active catalyst particle adherence. The smaller particles can be deposited inside the vacancies, as well as on an outer surface of the substrate, providing a more uniform non-carbon metal oxide support.

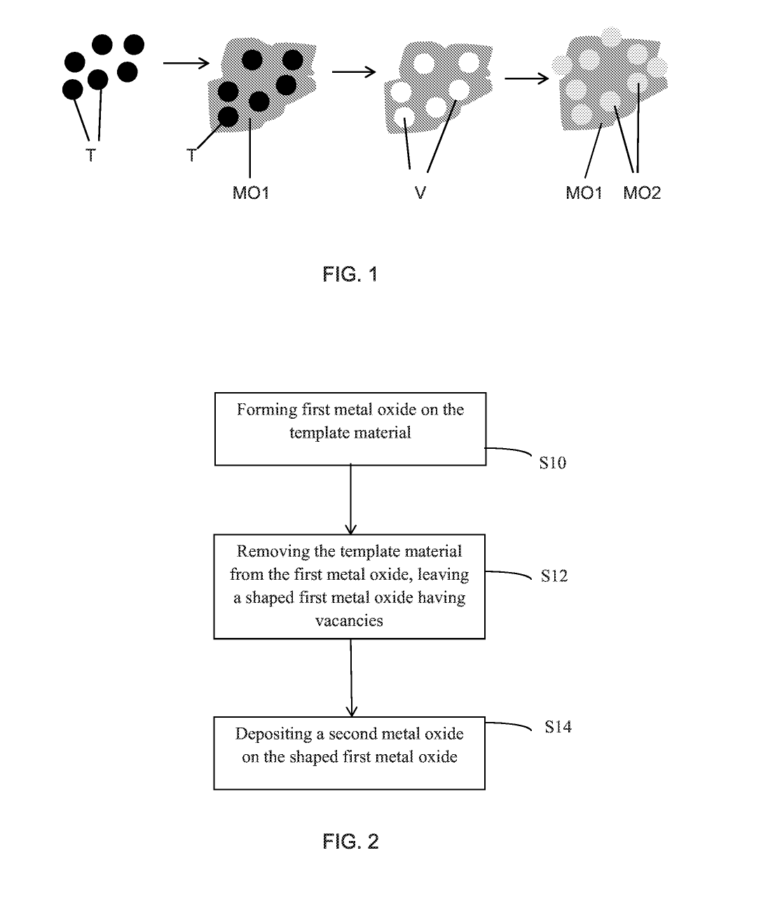

FIG. 2 is a flow diagram of a method of making the non-carbon metal oxide support particles illustrated in FIG. 1. First, a template material T is provided. The template material T can be, as non-limiting examples, silica or a polymer. Although illustrated as spheres in FIG. 1, the template material T can be provided in rods, tubes, lattice structures, etc., as desired or required, to obtain different substrate shapes and surface areas. The templated vacancies will retain the shape of the template material.

In step S10, a first metal oxide MO1 is formed around the template material T and dried. For example, the first metal oxide MO1 can be “grown” or formed on the template material T by first contacting the template material T with a chemical precursor of the first metal oxide MO1. The precursor is then reacted with a base, such as sodium hydroxide, in an aqueous environment to form metal hydroxides (M(OH)x). These metal hydroxides are then subsequently heated to form the first metal oxide MO1.

In step S12, the template material T is then removed from the first metal oxide MO1 using, as non-limiting examples, etching, acidic etching or burning. The result is a shaped substrate of the first metal oxide having vacancies and a high surface area. In step S14, a second metal oxide MO2 is deposited onto the shaped first metal oxide MO1 to form the non-carbon metal oxide support having a high surface area. For example, metal ions can be reduced onto the shaped first metal oxide substrate in a solution environment that facilitates the formation of fine particles. The metal can be converted to metal oxide by exposing the metal to air or oxygen.

Titanium oxide-ruthenium oxide (TiO₂—RuO₂) support is a non-limiting example of a non-carbon metal oxide support disclosed herein. Titanium oxide (TiO₂) has very good chemical stability in acidic and oxidative environments. However, titania is a semiconductor and its electron conductivity is very low. Substoichiometric titanium oxides (Ti₂O₃, Ti₄O₇, Magnéli phases) obtained by heat treatment of TiO₂ in a reducing environment (i.e., hydrogen, carbon) have electron conductivity similar to graphite as a consequence of the presence of oxygen vacancies in the crystalline lattice. However, the heat treatment process reduces the surface area of these materials, precluding the preparation of supported electrocatalysts with good Pt dispersion. To increase the surface area of the TiO₂, the TiO₂ is used as the first metal oxide MO1 and is templated, or shape-defined, as described herein. Ruthenium oxide (RuO₂) is then added as the second metal oxide MO2 to complete the support particles.

The particle size of the TiO₂ can be between about 25 and 35 nanometers, while the second particle size of the RuO₂ can be from about 1 nanometer to 5 nanometers. By depositing smaller RuO₂ particles onto larger TiO₂ particles, the amount of ruthenium used to produce the required activity is reduced, while the surface area of the non-carbon metal oxide support particle is increased. The electroconductivity of the non-carbon metal oxide support particles is also increased due to the network of RuO₂ particles on the enlarged surface of the support particles, including within the vacancies.

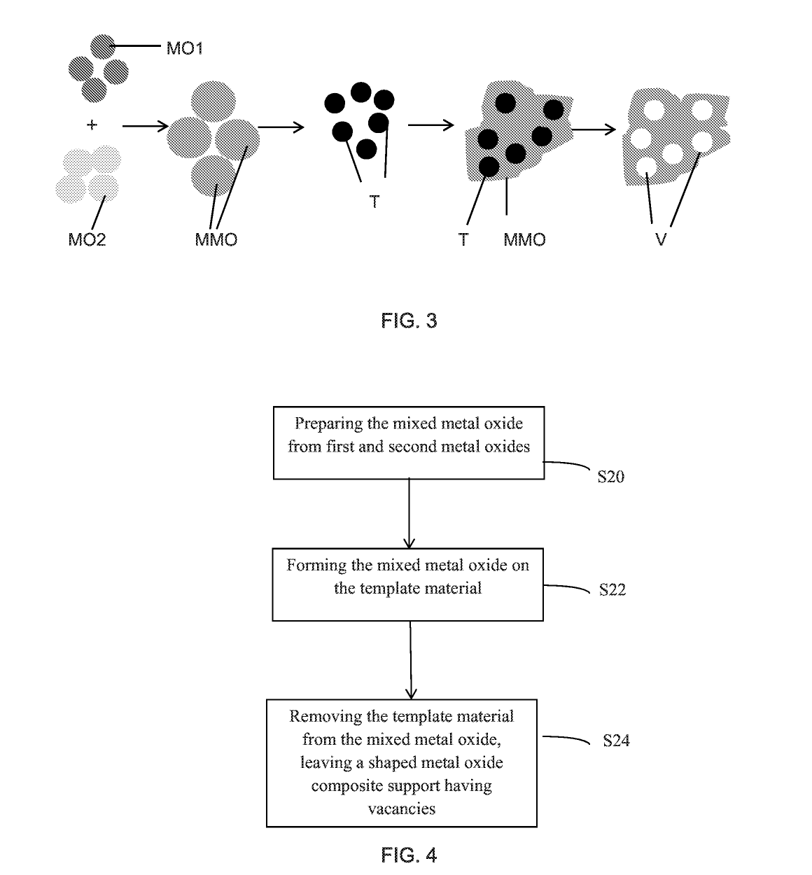

FIG. 3 is a schematic of a second embodiment of a non-corrosive non-carbon metal oxide support particle. In the second embodiment, a mixed metal oxide MMO is prepared from a first metal oxide MO1 and a second metal oxide MO2. The mixed metal oxide MMO is then formed around a templating material T. The templating material T is then removed, forming vacancies V in the mixed metal oxide MMO where the templating material T was removed. The resulting support is a non-carbon mixed metal oxide support having a high surface area.

FIG. 4 is a flow diagram of a method of making the non-carbon metal oxide support particles illustrated in FIG. 3. In step S20, the mixed metal oxide material MMO is prepared from the first metal oxide MO1 and the second metal oxide MO2. For example, the first metal oxide MO1 can be dispersed in liquid and mixed. The second metal oxide MO2 can be precipitated on the first metal oxide to form non-carbon composite support particles.

In step S22, the mixed metal oxide MMO is formed on the template material T. The template material T can be, as non-limiting examples, silica or a polymer. Although illustrated as spheres in FIG. 3, the template material T can be provided in rods, tubes, lattice structures, etc., as desired or required, to obtain different substrate shapes and surface areas.

In step S24, the template material T is removed from the mixed metal oxide MMO using, as non-limiting examples, etching, acidic etching or burning. The result is a shaped metal oxide composite support having vacancies, which increase the surface area of the composite support.

The first metal oxide MO1 and second metal oxide MO2 can have a similar particle size. As with the first embodiment, the shaped mixed metal oxide MMO of the second embodiment can be prepared using TiO₂ and RuO₂ as the first and second metal oxides MO1, MO2. The mixed metal oxide MMO can have a ratio of TiO₂ to RuO₂ ranging between 1:1 by weight to 0.8:0.2 by weight.

To prepare electrocatalyst using any of the embodiments of the templated non-carbon composite metal oxide support particles disclosed herein, active catalyst particles are deposited onto the templated non-carbon composite support particles. The active catalyst particles can be a precious metal such as platinum. Platinum nanoparticles having a diameter of 3 to 6 nanometers can be used as the active catalyst particles.

As an alternative to precious metal nanoparticles, precious metal alloys can be used as the active catalyst particles. For example, a platinum alloy can be deposited onto each non-carbon composite support particle to form the electrocatalyst, the platinum alloy including one or more additional precious or non-precious group metals such as Ru, Co, Ni, etc. By using an alloy, the platinum loading can be reduced while the activity of the catalyst can be maintained or increased.

Another alternative active catalyst particle that can be used with the non-carbon composite support embodiments disclosed herein is a core shell active catalyst particle. Core shell active catalyst particles are one or more layers of precious and/or non-precious metals on a core of a precious and/or non-precious metal. As a non-limiting example, a platinum nanoparticle core can be layered with one or more precious and non-precious metal group metals such as Ru, Co, Ni, etc. The core shell particles are deposited onto the templated non-carbon composite metal oxide support particles.

The electrocatalyst disclosed herein can be used in various applications, including proton exchange membrane fuel cells for vehicles and stationary power, direct methanol fuel cells, and other similar applications.

As a non-limiting example, the electrocatalyst can be used in a fuel cell, converting chemical energy to an electrical energy by using hydrogen as a fuel and oxygen/air as an oxidant. A fuel cell stack includes a plurality of membrane electrode assemblies, each generally comprising five layers, including a solid polymer electrolyte proton conducting membrane, two gas diffusion layers, and two catalyst layers. Fuel such as hydrogen is fed to the anode side of a membrane electrode assembly, while an oxidant such as oxygen or air is fed to the cathode side of the membrane electrode assembly. Coolant is supplied between the fuel and oxidant, the coolant separated from the fuel and oxidant by separators.

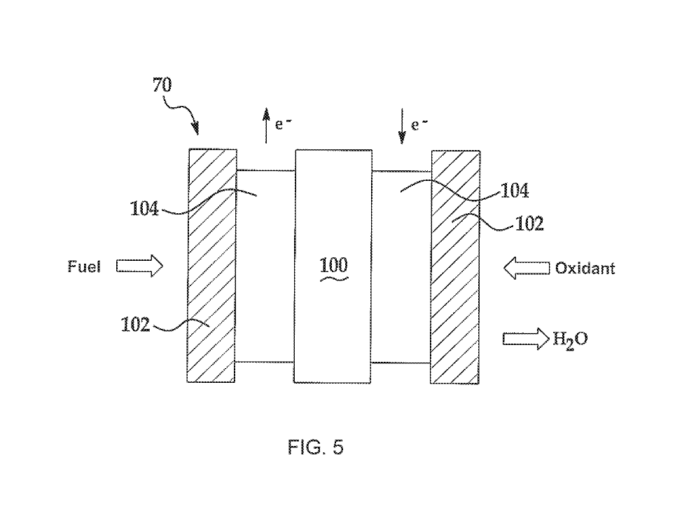

FIG. 5 is an illustration of one of the plurality of fuel cells 70 in the fuel cell stack. The fuel cell 70 is comprised of a single membrane electrode assembly. The membrane electrode assembly has an electrocatalyst coated membrane 100 with a gas diffusion layer 102 on opposing sides of the membrane 100. The membrane 100 has an electrocatalyst layer 104 formed on opposing surfaces of the membrane 100, such that when assembled, the electrocatalyst layers are each between the membrane 100 and a gas diffusion layer 102. Alternatively, a gas diffusion electrode is made by forming one electrocatalyst layer 104 on a surface of two gas diffusion layers 102 and sandwiching the membrane 100 between the gas diffusion layers 102 such that the electrocatalyst layers 104 contact the membrane 100. When fuel, such as hydrogen gas, is introduced into the fuel cell 70, the electrocatalyst layer 104 of the coated membrane 100 splits hydrogen gas molecules into protons and electrons. The protons pass through the membrane 100 to react with the oxidant, such as air, forming water (H₂O). The electrons (e⁻), which cannot pass through the membrane 100, must travel around it, thus creating the source of electrical energy.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of making a non-carbon support for an electrocatalyst comprising:
forming a metal oxide around a templating material; and
removing the templating material to produce vacancies in the metal oxide.

2. The method of claim 1, wherein the templating material is spherical in shape.

3. The method of claim 1, wherein the templating material is rod-shaped.

4. The method of claim 1, wherein the templating material is one of silica or a polymer.

5. The method of claim 1, wherein removing the templating material comprising etching or burning the templating material.

6. The method of claim 1, wherein the metal oxide is a composite metal oxide comprising a first metal oxide and a second metal oxide.

7. The method of claim 6, wherein the first metal oxide is titanium dioxide and the second metal oxide is ruthenium dioxide.

8. The method of claim 1, wherein the metal oxide is a first metal oxide, the method further comprising:
depositing a second metal oxide onto the first metal oxide having the vacancies to complete the non-carbon support, wherein the first metal oxide has a first particle size and the second metal oxide has a second particle size, the first particle size being greater than the second particle size.

9. The method of claim 8, wherein the first metal oxide is titanium dioxide and the second metal oxide is ruthenium dioxide.

10. A method of making an electrocatalyst comprising the steps of claim 1 and further comprising:
depositing active catalyst particles onto the non-carbon support.
